(19) United States
(12) Patent Application Publication
(10) Pub. No.: US 2014/0064207 A1
(43) Pub. Date: Mar. 6, 2014

(54) Methods and Devices for Selection of Random Access Channel

(71) Applicant: Telefonaktiebolaget L M Ericsson (publ), Stockholm (SE)

(72) Inventors: Edgar Ramos, Espoo (FI); Jose Luis Pradas, Stockholm (SE); Mats Sågfors, Kyrkslatt (FI)

(21) Appl. No.: 14/008,260

(22) PCT Filed: Aug. 2, 2013
(86) PCT No.: PCT/SE13/50949

§ 371 Date: Sep. 27, 2013

Related U.S. Application Data
(60) Provisional application No. 61/680,332, filed on Aug. 7, 2012.

(51) Int. Cl. H04W 74/08

(52) U.S. Cl. CPC H04W 74/0833
USPC 370/329

(57) ABSTRACT

Disclosed is, among other things, a method of physical Random Access Channel (PRACH) selection in a User Equipment, (UE) where the UE selects PRACH non-randomly from a list of candidate PRACHs.

### TECHNICAL FIELD

The present disclosure relates to methods and devices for selecting random access channels in a cellular radio network. In particular the disclosure relates to the selection of Physical Random Access Channel (PRACH).

### BACKGROUND

Cellular radio networks are constantly evolving and improved. The third generation partnership project (3GPP) standardizes the network. A major focus for all 3GPP Releases is to make the system backwards and forwards compatible where-ever possible, to ensure that the operation of user equipment is un-interrupted. In 3GPP, there is agreement to introduce concurrent 2 ms and 10 ms Transmission Time Interval (TTI) E-DCH (Enhanced Dedicated Channel) in CELL_FACH (RRC State for Random access and short transmissions). This also introduced some considerations in order to signal a User Equipment (UE) TTI selection that was solved by Physical Random Access Channel (PRACH) signature partition.

The further grouping of PRACH signatures increases the PRACH's blocking and transmission collision probabilities that can be seriously impacted by an anticipated traffic growth. One alternative proposed as a solution was introduction of additional PRACH scrambling codes in order to provide additional signatures to address the TTI signature partitioning.

Basic Deployment of PRACH Codes Prior Release-11

According to 3GPP Technical specification TS 25.331 section “8.5.17 PRACH selection” it is specified that the UE shall select the PRACH code randomly:

2> select a PRACH randomly from the list of candidate PRACHs as follows:

“Index of selected PRACH”=floor(rand*K)

where K is equal to the number of candidate PRACH system informations, “rand” is a random number uniformly distributed in the range 0≦rand<1 and “floor” refers to rounding down to nearest integer. The candidate PRACH system informations shall be indexed from 0 to K−1. The random number generator is left to implementation. The scheme shall be implemented such that one of the available PRACH system informations is randomly selected with uniform probability. At start-up of the random number generator in the UE the seed shall be dependent on the IMSI of the UE or time, thereby avoiding that all UEs select the same RACH;

After the selection of the PRACH index, then the UE proceeds with the signature selection based in the IE element Available Signature from “PRACH info” in case of proceeding with a RACH transmission or based in the IE element Available Signature from “PRACH preamble control parameters (for Enhanced Uplink)” in the case of E-DCH transmission.

Thus, the PRACH selection is the selection of the physical channel and follows the section 8.5.17.

Further sections 8.5.73 and 8.5.74 provides the parameters to of how to access a specific set of PRACH configurations. If several configurations exist the selection is done for such candidate configurations.

### E-DCH TTI Indication in CELL FACH

It has been agreed in 3GPP RAN2#76:

NW (Network) is informed of the UE's initial decision based on UE (RACH, Random Access Channel, access preamble) signature and if configured, the (RACH access preamble) scrambling code. Also, if something else in addition is needed is studied.

This agreement is intended to allow the possibility of enabling additional PRACH configurations where additional set of PRACH signatures could be deployed by a network operator in scenarios where there is a high traffic load. The signatures are used by the UE to signal to the network the selected E-DCH TTI in a network configured signature partition. The signature partition is to be implemented per each of the PRACH configurations and not necessarily being the same, meaning that two different PRACH configurations may have two different signature partitions to signal: Release-99 access, E-DCH 2 ms TTI and E-DCH 10 ms TTI. This is depicted in FIG. 1.

To make fully use of the possibility of deploying additional scrambling codes, all the TTI groups should be possible to have signatures allocated, as exemplified in FIG. 2. As shown by the example in FIG. 2 more complex configured in FIG. 1 can exist. Otherwise, it will in some cases be impossible for an operator enabling several scrambling codes to allow network TTI overriding with the currently discussed procedure. Additionally, the handling of some features, such as for example Fallback to release-99, HSDPCCH stand-alone, reduced RACH initial access time, can be simplified by separating the accesses between pre-release 11 UEs and release-11.

There is a constant desire to improve existing systems and to provide more efficient transmission in a cellular radio system. Hence there is a need for an improved PRACH selection.

### SUMMARY

It is an object of the present invention to provide an improved method and apparatus for improving the performance in a cellular radio network.

This object and others are obtained by the method and apparatus as set out in the appended claims.

As has been realized by the inventors, the introduction of the PRACH scrambling code as part of the signalling to the network on the E-DCH TTI selection makes the current PRACH selection obsolete and therefore should be updated in order to reflect a more discrete selection of PRACH information in order to cover the existing agreement, since a random selection of the PRACH index would lead to the UE neglecting some of the available E-DCH TTI configuration possibilities. This would harm the end user performance in some cases by not allowing the UE to select a suitable E-DCH TTI for the transmission even when the network is able to handle. Also, it would affect the freedom of the operators to increase the random access capacity in order to manage the future traffic increase of release-11 devices.

In accordance with some embodiments, when the network has configured several scrambling codes for UEs capable of 3GPP release-11 Further Enhanced CELL_FACH features, the UE is configured to select one scrambling code and the correspondent PRACH parameters to initiate the Random Access procedure in accordance with a pre-defined selection. Hereby the selection of PRACH index will become more predictable than in existing procedures.

Thus a method of physical Random Access Channel selection in a User Equipment where the UE is connectable to a cellular radio network, and where the UE selects PRACH non-randomly from a list of candidate PRACHs is provided.

In accordance with one embodiment a weight factors selection is employed, where the UE selects one scrambling code (PRACH configuration) from a list of candidates applying the respective weights to a uniform probability of selecting any of them. In accordance with other embodiments absolute priorities can be employed, based on for example, the index with each configuration has been defined, either on ascending or descending order.

Some embodiments can allow the network operator to distribute the traffic on all the available PRACH scrambling codes, but still forcing the selection of one of them for the majority of the UEs if desired or also force an absolute priority selection.

Other embodiments only provide an absolute priority selection option but the simplicity for implementation in both network and UE is very attractive and possibly enough for real network deployments.

The disclosure also extends to devices and in particular a UE for use in a cellular radio system and which is adapted to perform the methods as described herein. The devices can be provided with a controller/controller circuitry for performing the above processes. The controller(s) can be implemented using suitable hardware and or software. The hardware can comprise one or many processors that can be arranged to execute software stored in a readable storage media. The processor(s) can be implemented by a single dedicated processor, by a single shared processor, or by a plurality of individual processors, some of which may be shared or distributed. Moreover, a processor or may include, without limitation, digital signal processor (DSP) hardware, ASIC hardware, read only memory (ROM), random access memory (RAM), and/or other storage media.

### BRIEF DESCRIPTION OF THE DRAWINGS

The present invention will now be described in more detail by way of non-limiting examples and with reference to the accompanying drawings, in which:

FIG. 1 depicts a signature partition,

FIG. 2 illustrates an exemplary allocation of signatures,

FIG. 3 illustrates a cellular radio system,

FIG. 4 is a flowchart illustrating some steps performed when selecting PARCH, and

FIG. 5 illustrates a UE illustrates a radio base station.

### DETAILED DESCRIPTION

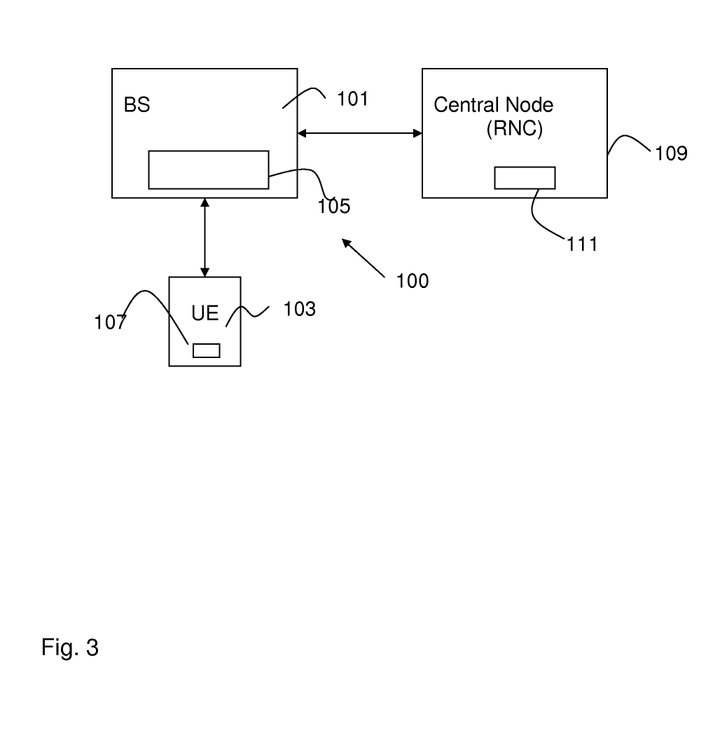

In FIG. 3 a general view of a cellular radio system 100 is depicted. The system 100 depicted in FIG. 3 is a system conforming to specifications specified by 3GPP. In particular the system can be a system conforming to 3GPP release 11. The exemplary system 100 comprises a number of base stations 101, whereof only one is shown for reasons of simplicity. The base station, BS, 101 can be connected to the user equipment in the figure represented by the UE 103 located in the area served by the base station 101. Further, the base stations 101 are controlled by a central node 109, such as a Radio Network Controller (RNC) in the case of an UTRAN system. The base station, the central node and the user equipment further comprise controllers/controller circuitry 105, 107 and 111 for providing functionality associated with the respective entities The controllers 105, 107 and 111 can for example comprise suitable hardware and or software. The hardware can comprise one or many processors that can be arranged to execute software stored in a readable storage media. The processor(s) can be implemented by a single dedicated processor, by a single shared processor, or by a plurality of individual processors, some of which may be shared or distributed. Moreover, a processor may include, without limitation, digital signal processor (DSP) hardware, ASIC hardware, read only memory (ROM), random access memory (RAM), and/or other storage media.

In order to enable the concurrent deployment of 2 ms and 10 ms TTI E-DCH in CELL_FACH, the UE does an initial TTI selection based in the power headroom calculated after the initial preamble power is determined Enabling additional scrambling codes in order to allow more flexibility for the signatures partitioning, means that the UE shall select the PRACH scrambling code that has configured signatures for the selected TTI. This is required since not all the TTI possibilities might be represented in each of the defined PRACH information per scrambling code.

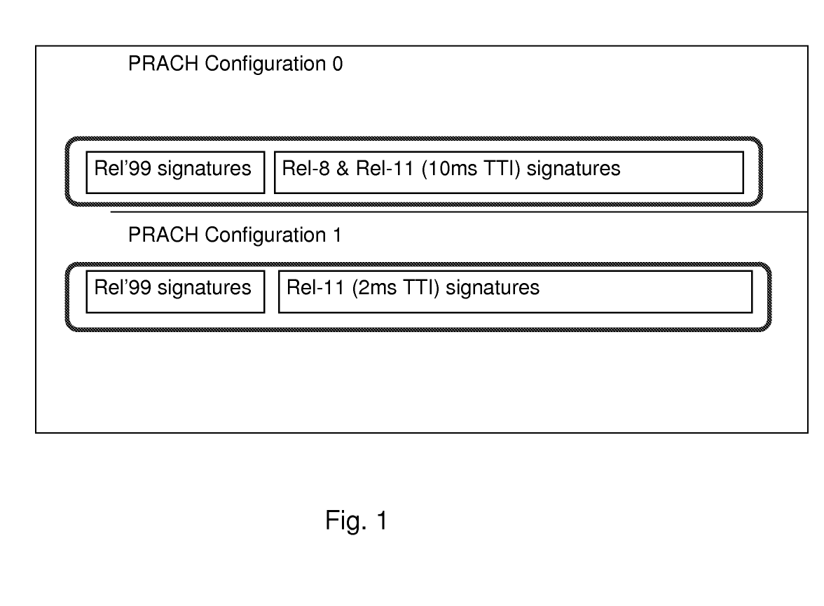

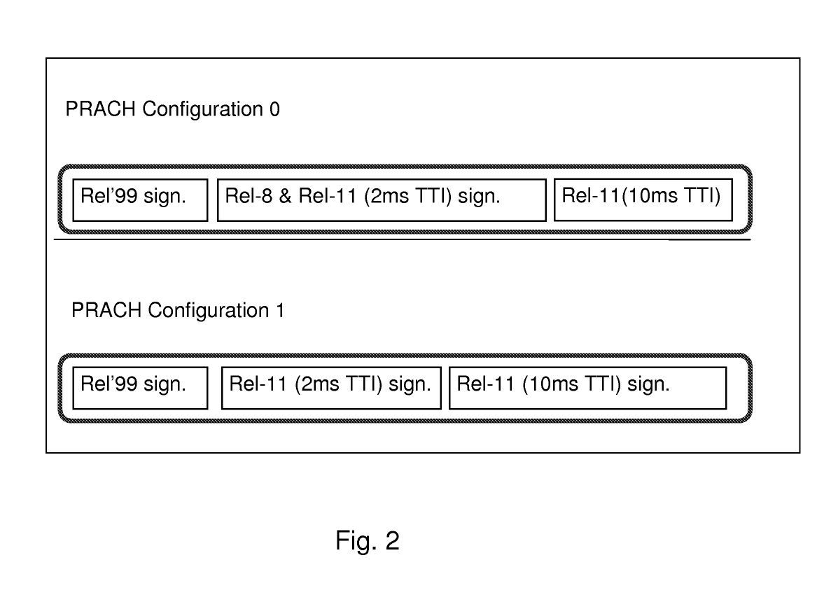

As is shown by the exemplary configuration in FIG. 2 there can be more complex configurations than showed in FIG. 1. The complexity of the configurations makes it advantageous to apply a more controlled deployment than just random selection.

The configuration of additional scrambling codes requires a definition of several “PRACH preamble control parameters (for Enhanced Uplink)”. Such a definition would mean that signature partition to indicate the E-DCH TTI might be present in several scrambling codes. Therefore a procedure for selection of one set of parameters to be applied for the Random Access is provided in order to make predictable for the network and clear for the UE what scrambling code, signatures, power thresholds, etc., should be used.

For that, a prioritized selection of the scrambling code (and hence PRACH preamble control parameters) is used to guide the selection thereby making the selection non-random.

One approach to the selection is to provide a parameter to provide a weight indicating which configuration the UEs should prefer. Based on such weight the UE can select one of the available configurations by selecting a configuration index which is the lowest possible value from the sum of the weights from the first configured index.

“Index of selected PRACH”=Min(Index)

Where Index is selected when:

$$rand \leq {\sum }_{index = [ k ]}^{ } {weight}_{index}$$

“rand” is a random number uniformly distributed in the range 0≦rand<1, k is the group of candidate indexes (e.g., 0, 1, 3) and weight is the normalized sum of all the weights divided between the given weight of the index.

$$( {weight}_{index} = \frac{{ConfiguredWeight}_{index}}{{\sum }_{m = [ k ]} {ConfiguredWeight}_{m}} )$$

In accordance with some embodiments the absence of a weight is the same than setting the weight to 0.

Alternatively, the PRACH preamble control parameters could be selected following an absolute prioritization based in the order of definition, where the highest index has the greater priority or the opposite, the highest index has the lowest priority.

When the selection of PRACH is not random in all aspects as described above the candidate priority can be set in a standard. In alternative embodiments the priorities can be communicated to the UE from the network or the priorities can be derived within the UE based on input available in the UE.

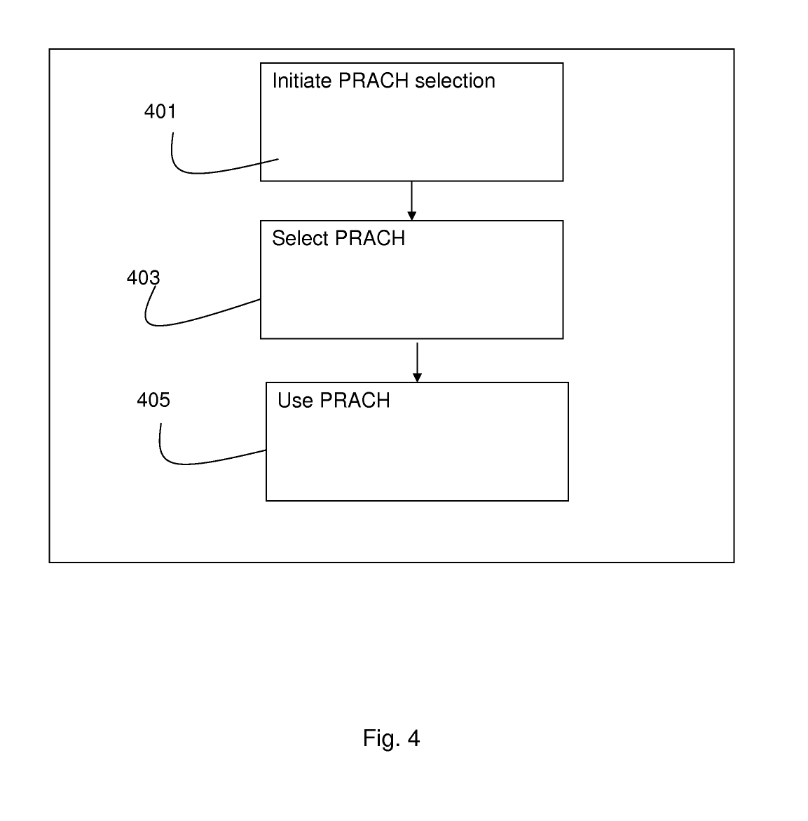

FIG. 4 is a flowchart illustrating some procedural steps that can be performed when selection of PRACH in a cellular radio network is performed. First in a step 401 it is determined that a PRACH needs to be selected. Next in a step 403 a PRACH is selected in accordance with a non-random procedure. In particular, any of the selection procedures as set out above can be used. The selection procedure can in all other aspects conform to the selection of PRACH as set out in 3GPP TS 25.331 section 8.5.17 prior to release 11. Then in a step 405 the selected PRACH is used.

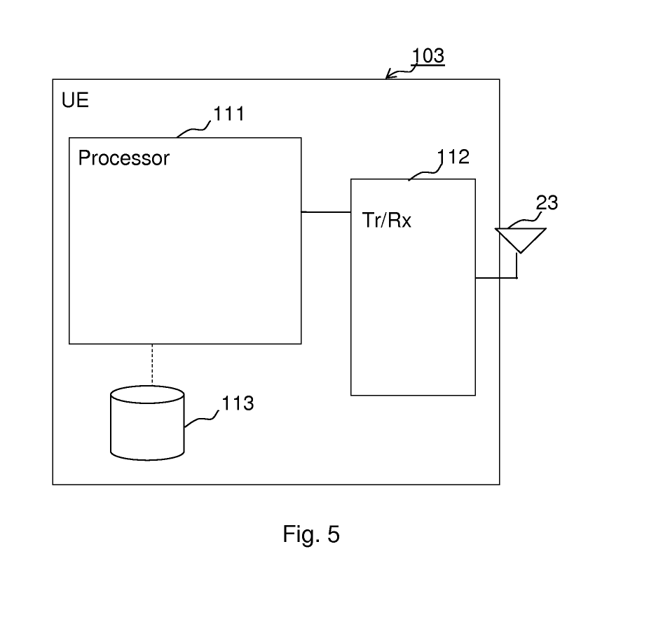

In FIG. 5 a UE adapted to use the above methods is depicted As shown in FIG. 5, the example UE 103 includes a processor 111, a memory 113, a transceiver 112, and an antenna 23. In particular embodiments, some or all of the functionality described above as being provided by mobile communication devices or other forms of mobile station may be provided by the mobile station processor 111 executing instructions stored on a computer-readable medium, such as the memory 113 shown in FIG. 5. Alternative embodiments of the mobile station may include additional components beyond those shown in FIG. 5 that may be responsible for providing certain aspects of the mobile station's functionality, including any of the functionality described above and/or any functionality necessary to support the solution described above.

Using method and devices as described herein can improve some of the available E-DCH TTI configuration possibilities. This will enhance the end user performance by allowing the UE to select a more suitable E-DCH TTI for the transmission. Also, the freedom for the operators to increase the random access capacity in order to manage the future traffic increase of release-11 devices can be improved.

1-14. (canceled)

15. A method of physical Random Access Channel, PRACH, selection in a User Equipment, UE, the UE being connectable to a cellular radio network, said method comprising the UE selecting PRACH non-randomly from a list of candidate PRACHs.

16. The method according to claim 15, wherein the PRACH selection is based on a prioritized list of candidates PRACHs.

17. The method according to claim 16, wherein each candidate in the list of candidate PRACHs is associated with a weight indicating the PRACH that is to be selected by the UE.

18. The method according to claim 17, wherein the absence of a weight corresponds to the setting of the weight to zero.

19. The method according to claim 17, wherein the UE based on the weight selects one of the available configurations by selecting a configuration index which is the lowest possible value from the sum of the weights from the first configured index as:
“Index of selected PRACH”=Min(Index)
where Index is selected when:
$$rand \leq {\sum }_{index = [ k ]}^{ } {weight}_{index} ,$$
where rand is a random number uniformly distributed in the range 0≦rand<1, k is the group of candidate indexes and weight is the normalized sum of all the weights divided between the given weight of the index as
$$( {weight}_{index} = \frac{{ConfiguredWeight}_{index}}{{\sum }_{m = [ k ]} {ConfiguredWeight}_{m}} ) .$$

20. The method according to claim 16, wherein the PRACH is selected based on an absolute prioritization order of definition, where a highest index has a greatest priority or a lowest priority.

21. The method according to claim 15, wherein the UE is a UE conforming to the Third Generation Partnership Program, 3GPP, specifications and supports at least concurrent 2 ms and 10 ms Transmission Time Intervals.

22. A User Equipment, UE, connectable to a cellular radio network, the UE comprising a transceiver and associated controller circuitry that is configured to select a Physical Random Access Channel, PRACH, non-randomly from a list of candidate PRACHs.

23. The UE according to claim 22, wherein the UE is configured to make the PRACH selection based on a prioritized list of candidates PRACHs.

24. The UE according to claim 23, wherein each candidate of the list of candidate PRACHs is associated with a weight indicating the PRACH that is to be selected by the UE.

25. The UE according to claim 24, wherein the absence of a weight corresponds to the setting of the weight to zero.

26. The UE according to claim 24, wherein the UE is configured to, based on the weight, select one of the available configurations by selecting a configuration index which is the lowest possible value from the sum of the weights from the first configured index as:
“Index of selected PRACH”=Min(Index)
where Index is selected when:
$$rand \leq {\sum }_{index = [ k ]}^{ } {weight}_{index} ,$$
rand is a random number uniformly distributed in the range 0≦rand<1, k is the group of candidate indexes and weight is the normalized sum of all the weights divided between the given weight of the index as
$$( {weight}_{index} = \frac{{ConfiguredWeight}_{index}}{{\sum }_{m = [ k ]} {ConfiguredWeight}_{m}} ) .$$

27. The UE according to claim 23, wherein the UE is configured to select PRACH based on an absolute prioritization order of definition, where a highest index has a greater priority; or the opposite, where a highest index has the lowest priority.

28. The UE according to claim 22, wherein the UE conforms to the Third Generation Partnership Program, 3GPP, specifications and is configured to support at least concurrent 2 ms and 10 ms Transmission Time Intervals.
